(19) United States
(12) Patent Application Publication
(10) Pub. No.: US 2005/0279676 A1
(43) Pub. Date: Dec. 22, 2005

(54) Fluid filter assembly for a dispensing faucet

(76) Inventors: Zuhair A. Izzy, Carmel, IN (US); Garry R. Marty, Fishers, IN (US); Kyle H. McMains, Frankfort, IN (US); Jeffrey L. Moore, Frankfort, IN (US); Christopher M. Coffey, Indianapolis, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/872,954

(22) Filed: Jun. 21, 2004

(51) Int. Cl. B01D 35/14; B01D 35/143

(52) U.S. Cl. 210/87; 210/94; 210/449; 210/100; 73/861.08

(57) ABSTRACT

A fluid filter assembly for a water dispensing faucet includes a housing assembly that is constructed and arranged to connect to a water dispensing faucet, a cover assembly that is threadedly attachable to the housing assembly for defining an interior receiving space therebetween and a replaceable filter cartridge installed into the receiving space and being constructed and arranged for filtering a flow of water before that water is delivered to the dispensing faucet. A plurality of reed switches are utilized that are responsive to changes in magnetic flux in order to provide electronic indications of filter status. Some of these electronic indications include the filter cartridge status in terms of its useful life, when a non-approved filter cartridge is installed, when there is no filter cartridge installed, when there is a water leak within the fluid filter assembly, and when one used filter cartridge has been replaced by a new filter cartridge.

### BACKGROUND OF THE INVENTION

The present invention relates in general to water delivery systems, including dispensing faucets of various styles and shapes. More specifically, the present invention relates to a fluid filter assembly construction that is cooperatively arranged with a dispensing faucet. According to the present invention, the incoming water is introduced into an under-the-sink portion. Once the water is processed through a filter cartridge that is part of the under-the-sink portion, the water flows into a hose that in turn routes the water to an exit port that is defined by the dispensing faucet.

While water dispensing faucets are known and while fluid filter assemblies are known, the merits or benefits of a new inventive embodiment for either a faucet or a fluid filter assembly or both are defined in terms of the features that are provided and by the overall functionality of the filter and faucet combination. The ability to design a product that is more reliable or more efficient or the ability to provide features that are more user friendly all constitute improvements in terms of fluid filter assemblies and dispensing faucets. Design features that provide added safety or security, or design features that may incorporate some type of fail-safe performance would also be considered improvements.

In terms of the present invention, design improvements are provided by various operational features that relate to monitoring and indicating status conditions and the assembly composition of the device. More specifically, the present invention allows for a simple installation, easy hook up, easy maintenance, and ease in the replacement of components. The maintenance and replacement of components are part of the overall ease of service for the construction provided by the present invention. The present invention represents a cost competitive product design that is capable of providing feedback to the customer/user on the status of the fluid filter assembly, its operational conditions, battery life, and whether there is an internal leak in the system. The feedback includes letting the user know when filtered water is flowing, when the flow is below the normal or target range (suggesting a possible clog), when the flow is above the normal range, when the filter cartridge needs to be replaced, when the batteries need to be replaced when an unapproved filter is being used, and whether or not there is an internal leak within the system.

Each of these design improvements are described herein in the context of a novel and unobvious fluid filter assembly for a dispensing faucet.

### SUMMARY OF THE INVENTION

A fluid filter assembly for a water dispensing faucet comprises a housing assembly that is constructed and arranged to connect to a spout of a water dispensing faucet, a cover assembly constructed and arranged to be removably attached to the housing assembly, the attached combination of said cover assembly and the housing assembly defining an interior receiving space. Included is a replaceable filter cartridge that is installed into the receiving space for filtering of flow of water before delivery to the dispensing faucet. The housing assembly includes a plurality of reed switches that are responsive to changes in magnetic flux in order to provide a plurality of electronic indications from the following group: an electronic indication of the filter cartridge status in terms of useful life, an electronic indication of when a non-approved filter cartridge is installed, an electronic indication of when there is no filter cartridge present, an electronic indication when there is a water leak within the fluid filter assembly, and an electronic indication when one filter cartridge has been replaced by another filter cartridge.

One object of the present invention is to provide an improved fluid filter assembly for a dispensing faucet.

Related objects and advantages of the present invention will be apparent from the following description.

### BRIEF DESCRIPTION OF THE DRAWINGS

FIG. 1 is an exploded view of a fluid filter assembly for a dispensing faucet according to a typical embodiment of the present invention.

FIG. 2 is an enlarged front elevational view, in full section, of a cover assembly comprising one portion of the FIG. 1 fluid filter assembly.

FIG. 3 is an enlarged front elevational view, in full section, of a housing assembly comprising a portion of the FIG. 1 fluid filter assembly.

FIG. 4 is an exploded view of the FIG. 3 housing assembly.

FIG. 5 is a side elevational view, in full section, of a diverter comprising a portion of the FIG. 3 housing assembly.

FIG. 6 is a front elevational view, in full section, of the FIG. 5 diverter.

FIG. 7 is a partial, side elevational view, in partial section, of a dispensing faucet that is suitable for use with the FIG. 1 fluid filter assembly.

FIG. 8 is a partial, front elevational view, in partial section, of the FIG. 7 dispensing faucet.

FIG. 9 is a partial, exploded view of a fluid filter assembly according to another embodiment of the present invention.

FIG. 10 is an enlarged, front elevational view, in full section, of a housing assembly comprising a portion of the FIG. 9 fluid filter assembly.

FIG. 11 is a partial, exploded view of the FIG. 10 housing assembly.

FIG. 12 is a front elevational view of a hose assembly comprising a portion of the FIG. 9 fluid filter assembly.

FIG. 13 is a front elevational view of a lightpipe assembly comprising a portion of the FIG. 9 fluid filter assembly.

FIG. 14 is a block diagram outlining the logical steps in data processing for the FIG. 9 fluid filter assembly.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

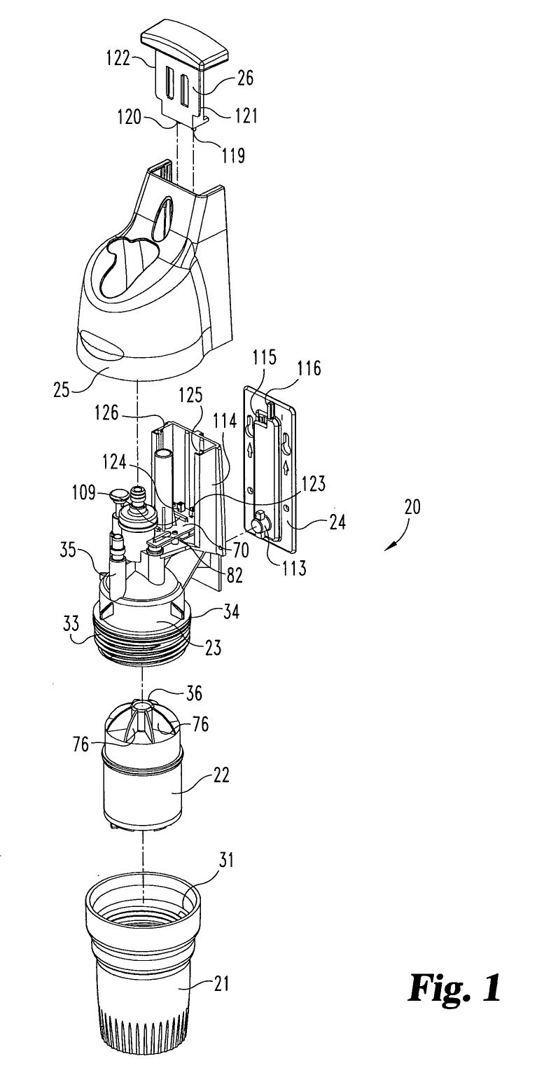

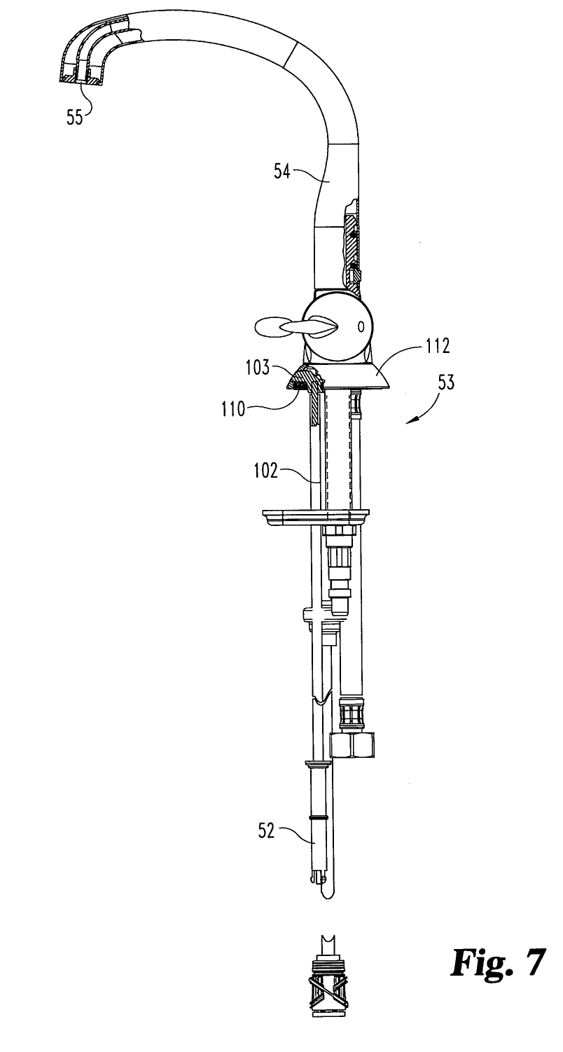

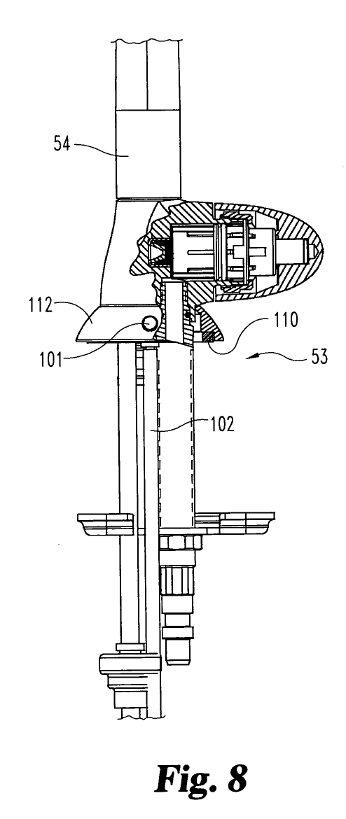

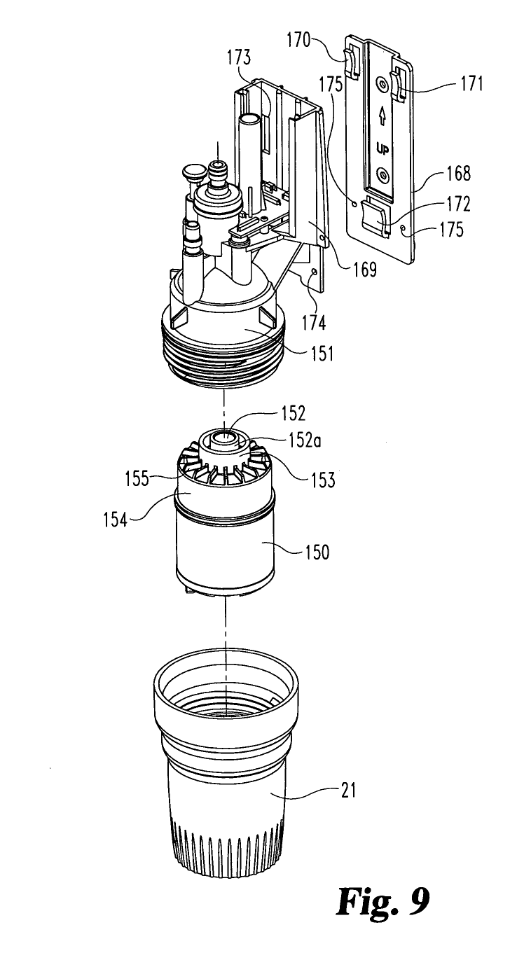

Referring to FIG. 1, there is illustrated a fluid filter assembly 20 that is used as part of a dispensing faucet according to the present invention. Although there are associated components that cooperate to deliver filtered water to the dispensing faucet, the components that comprise fluid filter assembly 20, as illustrated in FIG. 1, are assembled and positioned under the sink or counter associated with the dispensing faucet. In order to integrate the fluid filter assembly 20 with the dispensing faucet (see FIGS. 7 and 8), there are connections in terms of tubing or conduit for the water flow and, as will be described, the option for an electronic interconnect in order to provide electronic indications of fluid filter assembly status and conditions.

Fluid filter assembly 20 includes a cover assembly 21, filter element or filter cartridge 22, housing assembly 23, wall plate 24, cover 25, and battery holder 26. The details of cover assembly 21 are illustrated in FIG. 2 and importantly, housed within cover 27 is a flow totalizer that is secured within cover 27 by sonically welding the flow totalizer 28 in the desired location and with the desired orientation.

Filter cartridge 22 is a replaceable component that installs into cover assembly 21. Filter cartridge 22 has a designed useful life or life expectancy during which time its effectiveness as a filter is within the design parameters for this component. Since this usable filter life is not indefinite, it is important to know when the filtering capability is no longer within the design parameters such that it is time to discard the filter cartridge that is installed and replace it with a new filter cartridge. A suitable commercial product for filter cartridge 22 is a P\overline{u}R® brand cartridge, model number RF-4050L. An alternative construction for a suitable filter cartridge is illustrated in FIG. 9, as part of the FIG. 9 embodiment. A suitable commercial product for filter cartridge 150 is a P\overline{u}R® brand cartridge, model number RF-9999.

As illustrated herein, housing assembly 23 captures the upper portion of filter cartridge 22 and threads into the open end 31 of cover 27 that is, in a cooperative fashion, internally threaded. A first sealing gasket 32 is positioned in cover 27 as part of cover assembly 21. A groove 33 above the external threads of housing assembly 23 captures a quad ring 34 to seal the threaded engagement between housing assembly 23 and cover assembly 21. The quad ring lobe design of ring 34 represents a preferred design for higher pressure applications. Gasket 32 is important to help reduce the amount of air that can become trapped as the cover assembly 21 and housing assembly 23 are threaded together. It is known that the presence of air pockets, wherein the trapped air is compressed, creates an undesirable back pressure. The use of gasket 32 and its cooperative arrangement with quad ring 34 isolates a volume of trapped air and prevents this volume of trapped air from influencing the performance of the filter cartridge 22.

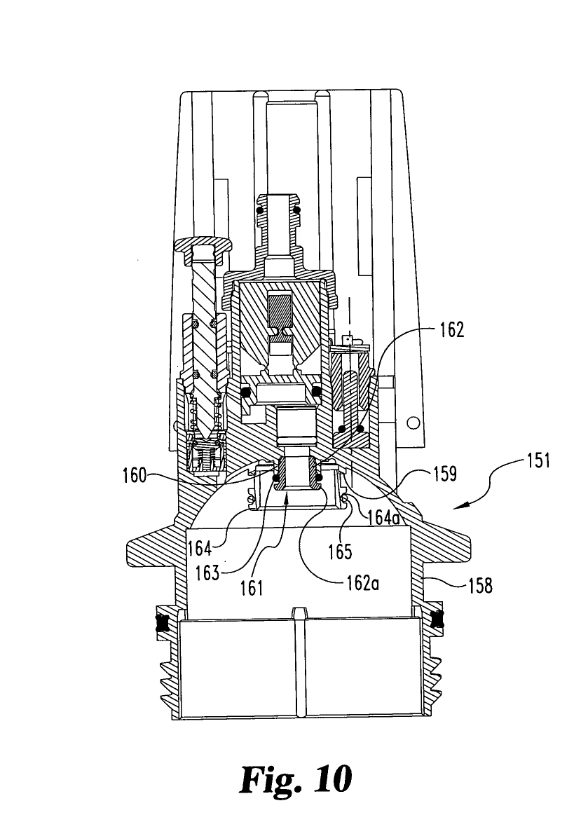

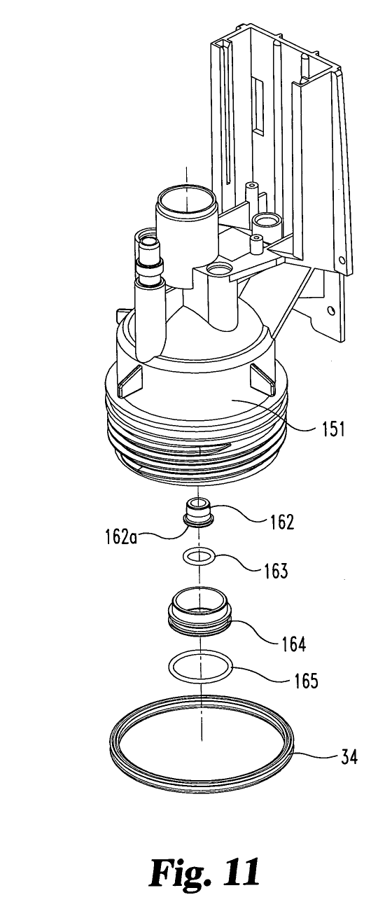

An alternative housing design is illustrated in FIG. 10. This alternative design is directed to a different style of sealing interface for the FIG. 9 filter cartridge. A partial, exploded view of the alternative housing design is illustrated in FIG. 11 showing the component parts that are assembled into the housing.

The flow totalizer 28 is constructed and arranged to measure the flow of water and, when appropriate, based on conditions that are monitored, shut off the water. In operation, water inlet 35 defines a hollow interior that is open into cover assembly 21. Water enters water inlet 35 and flows through the hollow interior in the direction of filter cartridge 22. The water flows around filter cartridge 22 to the bottom of cover 27. This flow of water goes through the mechanical flow totalizer 28 and turns gears that are part of the flow totalizer construction in order to measure the flow of water and, under certain conditions, actually shut off the water. The flow of water exits the flow totalizer 28 and flows into the filter cartridge 22.

The flow totalizer 28 is described in U.S. Pat. No. 5,525,214, issued Jun. 11, 1996 to Hembree and this issued patent is expressly incorporated by reference herein for its description of a suitable flow totalizer for the present invention, such as flow totalizer 28.

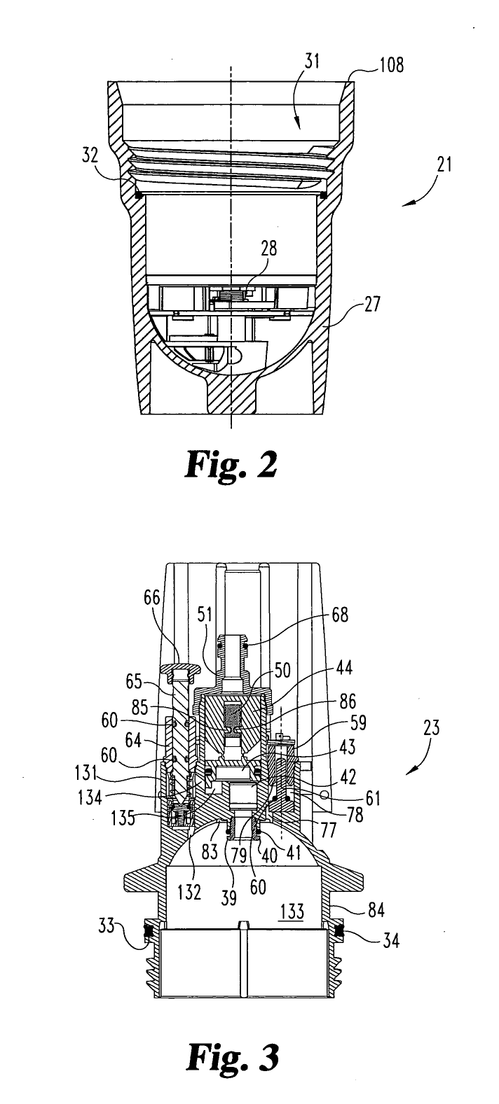

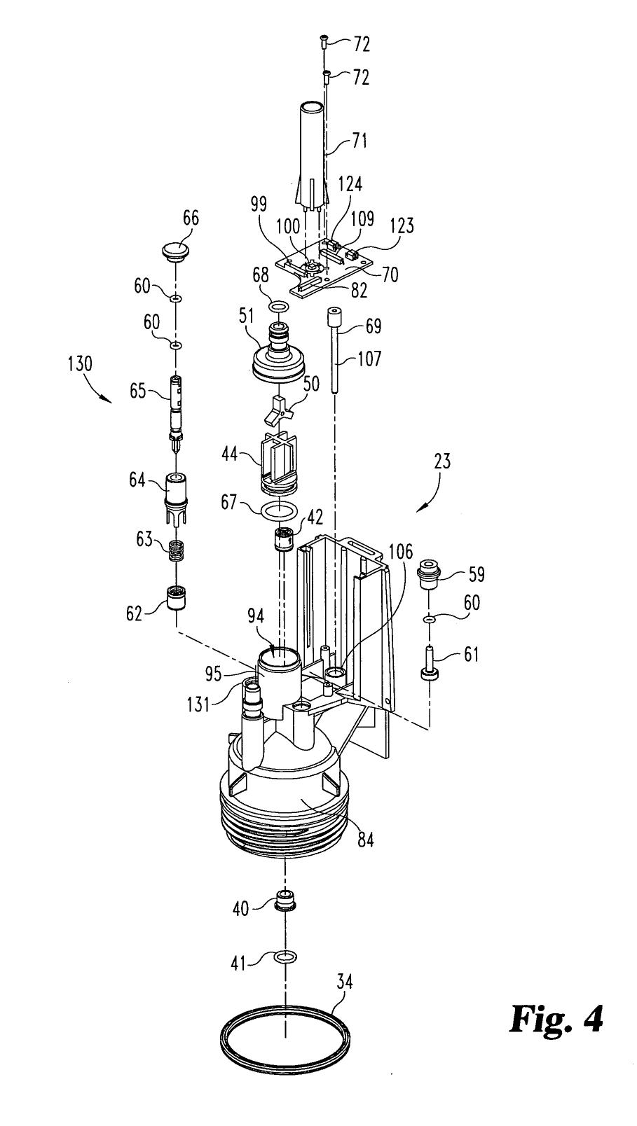

With continued reference to FIGS. 1 and 2 and with added reference to FIG. 3, the water traveling through filter cartridge 22 exits by way of outlet port 36 of filter cartridge 22 and flows into inlet port 39 that is part of housing assembly 23. Inlet port 39 is configured with an insert bushing 40 and an O-ring 41. This structure couples to outlet port 36 with a liquid-tight connection to prevent water leakage at that interface. Included as part of the housing assembly 23, now with reference to FIGS. 3 and 4, is a check valve 42 and an expansion volume 43. The water flowing into inlet port 39 travels up past the check valve 42 and into the expansion volume 43. The check valve 42 prevents water from draining down the water lines going to the faucet that could flood the sink cabinet when the cover assembly 21 is removed for replacement of the filter cartridge 22.

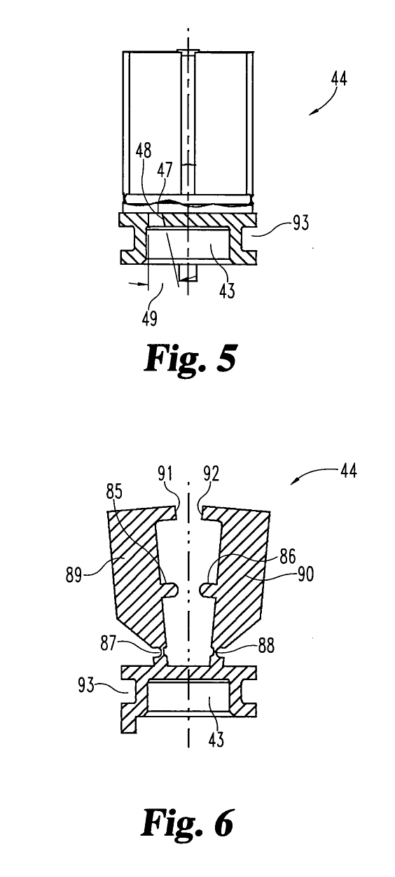

The diverter 44 that defines the expansion volume 43 is illustrated in FIGS. 3 and 4, as assembled, and in FIGS. 5 and 6 as a separate component part. The flow of water exits the expansion volume through hole 47 and it should be noted that hole 47 includes a tapered side 48 set at an angle 49 of approximately 10 degrees. As the water exits hole 47, it exits at an angle due to side 48. The angled flow of water is directed at the turbine impeller 50 (see FIG. 4), causing it to rotate. The water flow continues to move up and out through outlet cap 51 and from there into hose assembly 52 (see FIG. 7) of the faucet assembly. The water flow continues up through spout 53 and is dispensed by way of water port 54. The details of hose assembly 52 and its connectors are illustrated in FIG. 9.

With continued reference to FIG. 1, the filter cartridge 22 is captured between cover assembly 21 and housing assembly 23. With the cover assembly 23 threaded onto the housing assembly 23, the next steps in the assembly of fluid filter assembly 20 are to attach wall plate 24 and cover 25 and to insert battery holder 26. The configuration of housing assembly 23 is best illustrated by FIGS. 3 and 4. Looking at FIG. 4, some of the additional component parts that are illustrated include cap 59, O-rings 60, piston 61, check valve 62, spring 63, cap 64, plunger 65, button 66, O-ring 67, O-ring 68, plunger 69, circuit board 70, lightpipe support 71, and mounting screws 72. An alternative construction for a suitable wall plate is illustrated in FIG. 9.

Referring now to FIG. 3, it has been described that the filter cartridge 22 is constructed and arranged to couple to insert bushing 40, making a liquid-tight connection therewith so as to prevent any water leakage at that interface. If a non-standard or non-approved filter cartridge is attempted to be used as a replacement for or in lieu of the intended filter cartridge 22, leakage can occur. Any such leakage would flood the area of vanes 76 (see FIG. 1) as part of filter cartridge 22 and could then exit out the vent port 77 (see FIG. 3). A similar leakage issue exists if filter cartridge 150 is replaced with a non-standard or non-approved filter cartridge. Again, leakage can occur in the area of ribs 155. If nothing else is added, the leakage by way of vent port 77 (see FIG. 3) would find its way into the sink cabinet. Therefore, one improvement offered by the present invention is to assemble into the vicinity of vent port 77 a piston 61 with a magnetic portion and a sealing member that is preferably O-ring 60. The piston 61 and O-ring 60 are inserted into the vent port chamber 78. If there is a water leak for any reason, including the use of a non-standard or non-approved filter cartridge, the water pressure escaping through vent port 77 forces the piston 61 upwardly until the O-ring engages the sealing surface 79 which results in sealing off or sealing closed the vent port 77. The magnetic piston 61 is retained in housing assembly 23 by the use of cap 59. The cap 59 needs to be sealed in position to the body of the housing assembly 23 by welding or by the use of an elastomeric seal. A sonically welded joint is used for the preferred embodiment of fluid filter assembly 20.

Regarding the concern that a non-approved filter cartridge might be used, it should be noted that the interface between the filter cartridge 22 and the housing assembly 23 is critical in terms of its mechanical fit and the integrity of its liquid-tight sealing. If a on-approved filter cartridge is selected that does not have the required interface configuration for the requisite sealing, leakage can occur and, as noted above, if this condition does occur, the user needs to be advised. These same issues and concerns apply to the alternative filter cartridge design of FIG. 9 and the corresponding alternative housing assembly of FIGS. 10 and 11. If the interface design of the filter cartridge is protected by a patent, then this is one way to know that the only cartridges that fit properly are those that are approved and covered by a patent, excluding acts of infringement.

With continued reference to FIG. 3, the magnetizing of piston 61 provides additional capabilities and functions for fluid filter assembly 20. As the magnetized piston 61 moves in an upward direction due to water pressure by way of vent port 77, it moves close enough to circuit board 70 to be able to trigger a reed switch 82 that is mounted on circuit board 70. When the reed switch 82 is triggered, a signal is sent in the form of a flashing red light notify the user that something is wrong with the corresponding fluid filter assembly 20. This gives the user an opportunity to check the fluid filter assembly 20 and determine what has occurred or what has gone wrong and perhaps why. In the case of using a non-standard or non-approved filter cartridge, considering one that has been counterfeited to simulate an approved filter cartridge, a groove 83 is placed on the top surface of the main housing 84 to purposefully prevent a positive seal from being achieved. This in turn causes a leak so that the piston 61 will be moved and thereby reed switch 82 will be triggered.

Turbine impeller 50 is also a magnetized component that is housed in the unitary, molded plastic diverter 44. The actual assembly of impeller 50 into diverter 44 utilizes the pair of axially aligned shaft spuds 85 and 86 (see FIGS. 3 and 6) as the rotational shaft for the center hole of impeller 50. Importantly, in order to be able to expand the center clearance spacing between the facing tips of shaft spuds 85 and 86, living hinges 87 and 88 are provided as part of diverter 44. As will be understood, living hinges 87 and 88 permit side panels 89 and 90, respectively, to be pivoted or spread apart so as to increase the distance between the tips or facing ends of shaft spuds 85 and 86 without damaging any portion of diverter 44. With shaft spuds 85 and 86 spread apart, the impeller 50 can be easily assembled, without a risk of damage to the impeller. In order to keep the impeller 50 from binding up by side panels 89 and 90 closing in, support ribs 91 and 92 are provided as part of side panels 89 and 90, respectively. Abutment between the facing ends of ribs 91 and 92 establishes the minimum spacing between side panels 89 and 90. The use of O-ring 67 in annular groove 93 enables a hermetic seal between diverter 44 and the cylindrical bore 94 of sleeve 95 of main housing 84.

Filter life is measured by the number of rotations of impeller 50. As impeller 50 rotates, the magnetic flux of the impeller 50 trips or triggers a second reed switch 99 that is mounted to circuit board 70. Each one full revolution of impeller 50 allows a set amount of water flow to occur and one count is captured or recorded by reed switch 99. By means of this cooperative mechanical and electrical relationship, a correlation between the impeller rotations (i.e., counts) and the water flow rate (volume) is established. By counting the number of rotations (i.e., reed switch 99 counts) enables a flow volume in gallons of water to be established. Software is provided that compares the reed switch counts to whatever has been defined in terms of the counts-to-flow volume relationship in order to accurately determine, at any moment in time, the flow usage progress of the filter cartridge 22.

As water flow begins, an electronic signal alerts LED 100 that is also mounted to circuit board 70 to turn on (i.e., illuminate). Initially the LED illuminates in green and this “go” color alerts the user to the condition that filtered water is flowing. At preset cumulative flow volume levels, the color of LED 100 changes from green to amber to alert the user that the filter cartridge 22 has been used up to a certain amount. For example, the LED 100 could change from green to amber once eighty percent (80%) of the useful life or capacity of the filter cartridge 22 has been consumed. When the end of the useful life of filter cartridge 22 is reached, the corresponding electronics/software of fluid filter assembly 20 cause the color of LED 100 to change to red. This color (red) informs that user that it is time to replace the filter cartridge 22. At roughly the same time that LED 100 goes to red, the flow totalizer 28 (see FIG. 2) operates by way of a ball valve structure that blocks the flow of water. When the ball blocks the water passage, the flow of water is stopped and this condition also means that it is time to change or replace filter cartridge 22. Even if the user does not see the red LED illumination, when the water flow stops, the user is aware of some problem or condition. The red light that will be visible at the faucet confirms that it is time to replace filter cartridge 22. It should be noted that all LED illumination requires the flow of water.

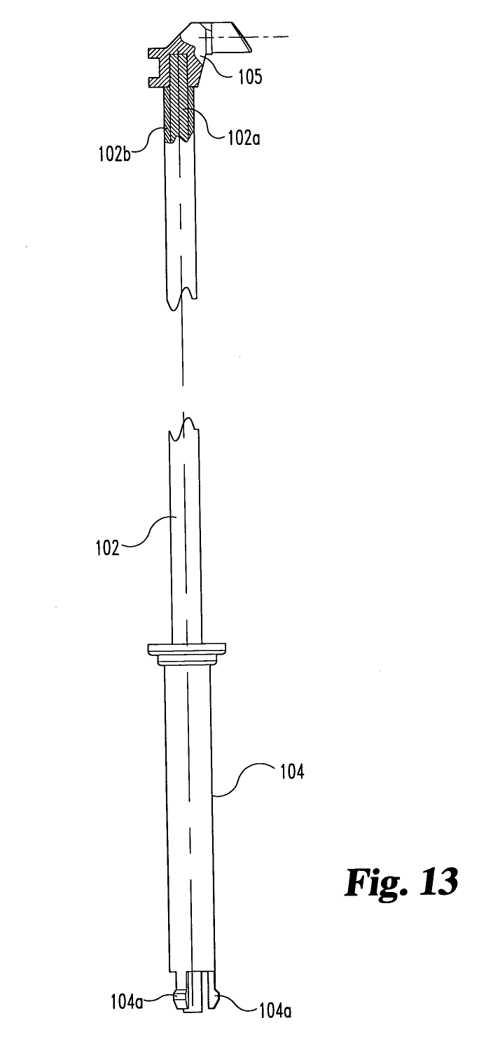

The light from LED 100 is preferably coupled to a faucet mount lens 101 (see FIG. 8) by the use of a fiber optic cable 102 that is part of the lightpipe assembly 103 (see FIGS. 7, 8 and 13). An alternative construction is to actually mount the LED 100 in the faucet mount and utilize wire connections to circuit board 70. With reference to FIGS. 7, 8 and 13, the lightpipe assembly 103 includes, in addition to fiber optic cable 102, a base 104 and a header 105. The cable 102 includes a fiber optic element 102a and an outer polyethylene jacket 102b. The base 104 is designed with snap-fit prongs 104a for receipt by lightpipe support 71. Support 71 is positioned over the LED 100 and is preferably ultrasonically welded to the surface of circuit board 70. The transmissive open end of cable 102 is positioned in close proximity to LED 100 for receiving the emitted light with minimal loss or diffusion. The prongs 104a in cooperation with the interior design of support 71 control the positioning of the cable 102 relative to the LED 100. A uniquely shaped elastomeric gasket 110 is fitted around header 105 so as to both securely capture the header 105 within base 112 and provide sealing at that location.

With continued reference to FIG. 4, in order to reset the flow measurement count once the filter cartridge 22 is replaced, plunger 69 is used. First, it should be noted that plunger 69 is magnetized and is assembled into housing assembly 23 by being mounted into mating bore 106. The long pin portion 107 of magnetic plunger 69 rests on an annular ledge 108 defining the open end of cover 27 (see FIG. 2). As the cover assembly 21 is unscrewed from the housing assembly 23, the pin portion 107 and the remainder of the magnetized plunger 69 moves in a downward direction. Moving in this direction means that plunger 69 moves farther away from a third reed switch 109 that is mounted onto circuit board 70. The movement of plunger 69 in this downward direction results, at least by the end of its travel, in the loss of magnetic flux from plunger 69 that would otherwise be sensed by reed switch 109. This loss of magnetic flux causes the third reed switch 109 to reset the counter measuring flow to zero (0). This therefore provides a reset to zero at the same time a new filter cartridge is being installed. When the flow through the filter cartridge resumes, the count resumes for the desired water flow measurement.

The various performance features and capabilities of circuit board 70 and the operation of LED 100 in response to various inputs and conditions are controlled by a controller module (not illustrated) that includes all of the electronic monitoring circuitry for the fluid filter assembly. This controller module uses a battery module for power. A suitable location for the controller module, as part of fluid filter assembly 20, is in the vicinity of the impeller 50. One function of the controller module is to sense and count the rotation of the magnetic field from the magnetic impeller 50. This count is stored in a non-volatile memory during battery replacement. The count is zeroed when the filter cartridge is replaced in order to start over with a new filter cartridge.

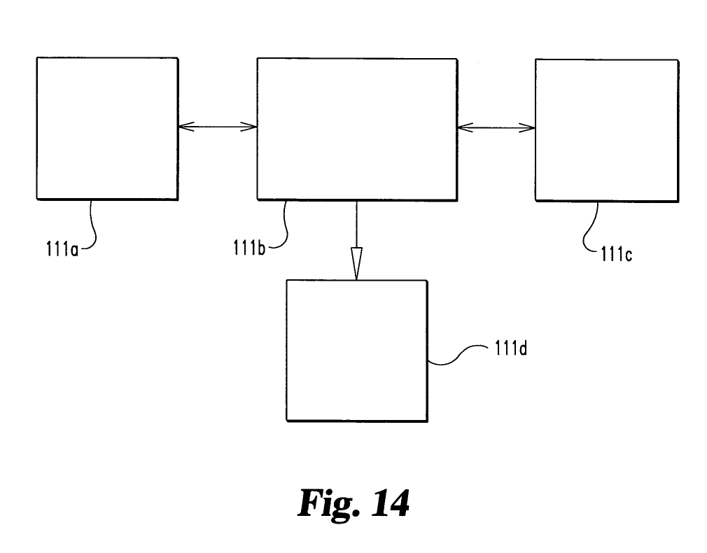

A system block diagram for the control function is illustrated in FIG. 14. Block 111a provides the inputs to block 111b which represents the controller module and the bi-colored LED 100. The input from block 111c represents battery power from two AA batteries, 3 Vdc, nominal. The outputs from block 111b go to the lightpipe assembly 103. The inputs from block 111a include the reed switch signals for counting, resetting, and venting. The LED indicators include red, green, and “amber” as previously described, noting that the combination of red and green creates this third color. A blocking diode is preferably included for a reverse voltage protection feature.

The controller module enters the sleep mode of operation after 500 ms after the flow has stopped from the faucet and the impeller 50 has stopped rotating. This mode is a low power condition for the controller module in order to preserve battery life. The controller module stays in this sleep mode until an interrupt is sensed by the controller module due to either impeller rotation as the faucet is opened up or activation of a reset signal. When the faucet is opened up, the controller module enters its wake up mode. The controller module enters the initialization mode of operation once the batteries have been inserted and battery power is applied. All interrupts, timers, initializing variables occur on power-up. The controller module counts switch closures to ground on a count input port as the impeller 50 rotates past the corresponding reed switch. One pulse per revolution is counted as the impeller rotates due to water flow through the filter housing. It is anticipated for this overall structure to be accurate within one percent (1%) for a flow range of between 0.3 and 0.7 gallons per minute. The pulse count is stored in a temporary register while the impeller is rotating. Once the impeller rotation is completed, the totalized value is stored in the non-volatile section of the controller module (EEPROM) as the controller module goes to its sleep mode.

Referring again to FIG. 1, fluid filter assembly 20 is constructed and arranged to be mounted to a cabinet or structure wall by means of wall plate 24. Conventional mounting hardware, such as screws, can be used for the mounting of wall plate 24. A bayonet connection 113 on the bottom of wall plate 24 is constructed and arranged to cooperate with a mating hole that is molded into the back panel portion 114 of housing assembly 23. The mating hole is oriented at a 45 degree turn relative to the likely vertical orientation of wall plate 24. This means that the housing assembly 23 must be turned 45 degrees from vertical in order to assemble onto bayonet connection 113. Once this initial assembly is effected, the housing assembly 23 is turned 45 degrees back to vertical. This in turn locks the housing assembly 23 on to the bayonet connection 113 of wall plate 24. A snap member 115 locks the housing assembly 23 to the wall plate 24 with a tactile and audible snap. A stop 116 keeps the housing assembly 23 from being rotated past its intended orientation relative to the wall plate. This preferred orientation is vertical.

One design modification contemplated for the present invention is to include a cored in receptacle molded into wall plate 24 that will accept a molded-in tab as part of housing assembly 23. This combination is constructed and arranged to lock in the top portion of the housing assembly 23 to the wall plate 24 to give added support and more stability to the connection of housing assembly 23 to wall plate 24.

With continued reference to FIG. 1, battery holder 26 includes contact prongs 119 and 120 and outwardly extending wall sections 121 and 122. Holder 26 is constructed and arranged to house the batteries required for the intended operation and functioning of fluid filter assembly 20. Circuit board 70 includes mating contacts 123 and 124 that are designed for the mechanical and electrical receipt of contact prongs 119 and 120, respectively. Back panel portion 114 is a molded structure that is shaped with guide tracks 125 and 126. Tracks 125 and 126 receive wall sections 121 and 122, respectively, so as to guide and align the insertion of prongs 119 and 120 into contacts 123 and 124.

The described electronics for fluid filter assembly 20 that control the green, amber, and red illumination of LED 100 are constructed and arranged to provide a blinking or flashing amber light when the batteries need to be replaced. If there is a leak between the filter cartridge 22 and the housing assembly 23, there is a flashing red light from the LED 100, alerting the user that something is wrong with the fluid filter assembly 20. When the batteries are changed, the LED 100 blinks red/green for ten seconds as an indication of the proper installation of the batteries. The controller module that controls these electronics retains in its memory the count and flow life of the filter cartridge 22 that has been already used or consumed so that this information is not lost when the battery is changed.

With continued reference to FIGS. 3 and 4, there is illustrated a mechanical air vent assembly 130 that is included as part of housing assembly 23. Sleeve 131 is a unitary portion of main housing 84 that receives the components which comprise the mechanical air vent assembly 130. These components include check valve 62, spring 63, cap 64, plunger 65, button 66, and O-ring 60. In a cooperative arrangement, the main housing 84 defines a vent hole 132 leading from the interior 133 of main housing 84 into the generally cylindrical interior of sleeve 131. A connecting passageway 134 leads from the interior of sleeve 131 to outlet 135. Outlet 135 is open to the hollow interior of outlet cap 51.

When the housing assembly 23 and cover assembly 21 are threaded together to enclose filter cartridge 22, there is a possibility for air to become trapped within the interior 133 of the fluid filter assembly 20. Trapped air within fluid filter assembly 20 will experience compression and subsequent expansion and, even with the faucet valve shut off, continued flow, albeit limited in volume, through the faucet outlet is possible. This is an effect of not having the entire unit (fluid filter assembly 20) under line pressure while not in use where the faucet valve is upstream and water is routed through the filter cartridge only during usage.

The usage of air vent assembly 130 begins with the manual depression of button 66 in a downward direction. This action causes the spring-biased plunger 65 to move in a downward direction so as to open check valve 62. The opening of check valve 62 enables trapped air and any air/water mixture to flow through vent hole 132. The flow into sleeve 131 by way of vent hole 132 subsequently flows out of sleeve 131 and into outlet 135 by way of connecting passageway 134. Check valve 42 prevents any back flow of water through the fluid filter assembly 20. O-rings 60 (two places) are constructed and arranged to prevent water from leaking through the air vent assembly 130 while in use. When not in use, the springs 63 and check valves assure that this air vent is closed when no activation force is applied to button 66.

Referring now to FIG. 9, an alternative filter cartridge 150 is illustrated. The primary difference between filter cartridge 150 and filter cartridge 22 is directed to the design of the connecting interface with the corresponding housing assembly. The alternative construction of filter cartridge 150 requires an alternative design for the housing assembly and this alternative design is illustrated in FIGS. 10 and 11 with regard to housing assembly 151. The remainder of filter cartridge 150, including its interior construction and performance, is substantially the same as that of filter cartridge 22.

Filter cartridge 150 includes a generally cylindrical outlet port 152 defined by wall 152a and a concentric surrounding cylindrical wall 153. Extending between the outer surface of wall 153 and the inside surface of generally cylindrical cartridge wall 154 are a series of equally-spaced ribs 155. The remainder of filter cartridge 150 including its assembly and fit into cover assembly 21 is virtually the same as that of filter cartridge 22.

With reference to FIGS. 10 and 11, the structural details of housing assembly 151 are illustrated. The only difference between housing assembly 151 and housing assembly 23 is in the area of the sealed interface with filter cartridge 150. The main housing 158 is changed in design compared to main housing 84 by adding a surrounding cylindrical wall 159 around the cylindrical wall 160 that defines inlet port 161.

In order to configure main housing 158 to receive filter cartridge 150 with the required sealed interface, additional components are assembled into the main housing 158 for acceptance of filter cartridge 150. These components are illustrated in FIGS. 10 and 11 and include insert bushing 162, O-ring 163, sleeve 164, and O-ring 165. The quad seal 34 is the same as that used for housing assembly 23. As is illustrated in FIG. 10, bushing 162 is pressed into port 161 and O-ring 163 is captured between the free edge of wall 160 and the radial flange 162a of bushing 162. Sleeve 164 is pressed into wall 159 and O-ring 165 is captured by groove 164a.

With the main housing 158 configured as described and illustrated, the filter cartridge 150 installs by inserting outlet port 152 over and around bushing 162, O-ring 163, and inlet port 161. It is intended for this to be a tight fit so as to compress O-ring 163 in order to establish a secure, liquid-tight interface. Wall 152a fits between bushing 162 and sleeve 164. The outer wall 153 is constructed and arranged to receive sleeve 164 and O-ring 165 with a secure, liquid-tight interface, compressing O-ring 165 to establish the desired sealing. The prior discussion regarding the protecting of this interface to try and prevent the use of non-approved filter cartridges applies to the alternative design of FIGS. 9-11. If a non-approved filter cartridge is attempted to be used, a warning indication of this condition is provided to the user.

With continued reference to FIG. 9, an alternative design for wall plate 24 is illustrated as wall plate 168. Instead of requiring a 45 degree turn of back panel portion 114 for assembly with the wall plate 24, wall plate 168 and back panel portion 169 assemble by relative vertical movement. Wall plate 168 includes upwardly opening clips 170, 171, and 172. Back panel portion 169 includes corresponding slot openings, one of which is illustrated in FIG. 9 as slot 173. By positioning the back panel portion 169 so that its three slots line up with the three clips 170-172, the back panel portion 169 can be pushed against wall plate 168 so as to insert each clip into its corresponding slot. Thereafter, back panel portion 169 slides down so as to seat the top edge of each slot against the closed base of each clip. Two holes 174 in back panel portion 169 cooperate with raised bumps 175 for a snap-fit receipt in order to give a tactile and audible indication that the back panel portion 169 is properly seated onto wall plate 168.

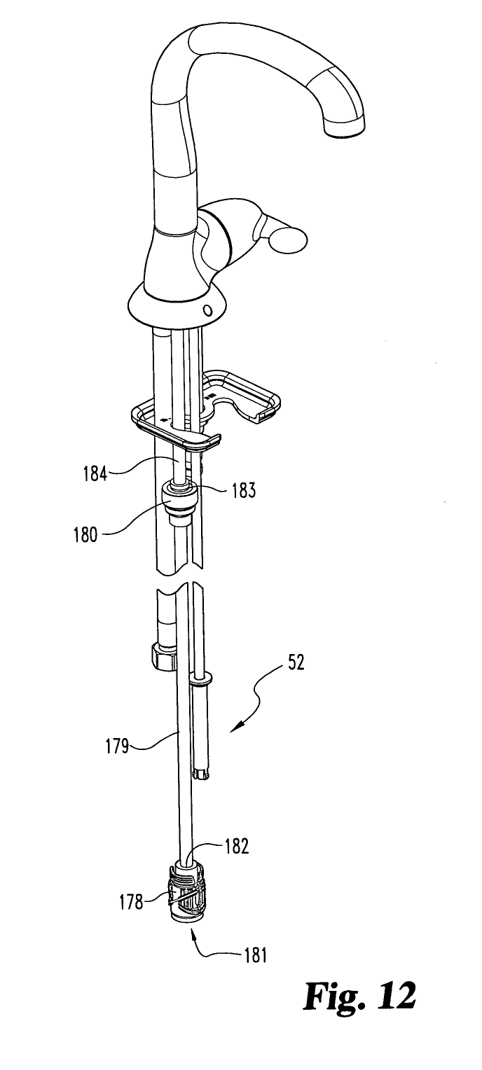

With reference to FIG. 12, the details of hose assembly 52 are illustrated. Hose assembly 52 includes a quick-connect fitting 178, a length of tubing 179, and a push-to-connect pressure fitting 180. Fitting 180 is similar in design to products offered by John Guest USA, Inc. of Pine Brook, N.J., and sold under their SUPER SPEEDFIT® trademark. Instead of using the John Guest USA, Inc. style that is connectable at both ends, only one half of that style of fitting is used for fitting 180. The open end 181 is constructed and arranged to connect to outlet cap 51 with a simple, quick-connect assembly. The opposite end of tubing 179 is anchored into fitting 180. The open end 183 of fitting 180 is constructed and arranged with an elastomeric seal having a defined inside diameter that is smaller than the outside diameter of the tubing 184 it is designed to receive. This size difference creates a pressure fit (interference) for establishing the desired sealing and a secure mechanical connection.

The use of synthetic materials for hose assembly 52 prevents the water being routed therethrough from coming in contact with metal. Since metallic contaminants are being taken out of the water by the filter cartridges 22 and 150, it is counterproductive to reintroduce such contaminants back into the water downstream from the filter cartridge.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A fluid filter assembly for a water dispensing faucet comprises:
a housing assembly that is constructed and arranged to connect to a spout of a water dispensing faucet;
a cover assembly constructed and arranged to be removably attached to said housing assembly, the attached combination of said cover assembly and said housing assembly defining an interior receiving space;
a replaceable filter cartridge installed into said receiving space for filtering a flow of water before delivery to said dispensing faucet; and
wherein said housing assembly includes a plurality of reed switches that are responsive to changes in magnetic flux in order to provide a plurality of electronic indications from the following group of electronic indications, including an electronic indication of the filter cartridge status in terms of useful life, an electronic indication of when a non-approved filter cartridge is installed, an electronic indication when there is no filter cartridge installed, an electronic indication when there is a water leak within the fluid filter assembly, and an electronic indication of when one filter cartridge has been replaced by another filter cartridge.

2. The fluid filter assembly of claim 1 wherein said plurality of reed switches includes three reed switches, wherein a first reed switch is used to sense leakage.

3. The fluid filter assembly of claim 2 wherein a second reed switch is used to measure the volume of water that has flowed through said fluid filter assembly.

4. The fluid filter assembly of claim 3 wherein a third reed switch is used to reset a flow measuring counter to zero when a replacement filter cartridge is installed.

5. The fluid filter assembly of claim 4 wherein a magnetized, movable plunger is used to trigger said third reed switch.

6. The fluid filter assembly of claim 2 wherein said housing assembly further includes a circuit board, said three reed switches being assembled to said circuit board.

7. The fluid filter assembly of claim 6 which further includes a battery holder, said battery holder being constructed and arranged to slide into electrical contact with said circuit board.

8. The fluid filter assembly of claim 1 which further includes a LED that is constructed and arranged to produce a plurality of different illumination colors for indicating fluid filter assembly conditions.

9. The fluid filter assembly of claim 8 which further includes a remotely-located lens that is operably coupled to said LED to give visual indications of fluid filter assembly conditions.

10. The fluid filter assembly of claim 9 wherein the operable coupling between said lens and said LED is by the use of a fiber optic lightpipe.

11. The fluid filter assembly of claim 10 wherein said plurality of reed switches includes three reed switches, wherein a first reed switch is used to sense leakage.

12. The fluid filter assembly of claim 111 wherein a second reed switch is used to measure the volume of water that has flowed through said fluid filter assembly.

13. The fluid filter assembly of claim 12 wherein a third reed switch is used to reset a flow measuring counter to zero when a replacement filter cartridge is installed.

14. The fluid filter assembly of claim 13 wherein a magnetized, movable plunger is used to trigger said third reed switch.

15. The fluid filter assembly of claim 1 wherein one reed switch is used to measure the volume of water that has flowed through said fluid filter assembly.

16. The fluid filter assembly of claim 1 wherein one reed switch is used to reset a flow measuring counter to zero when a replacement filter cartridge is installed.

17. The fluid filter assembly of claim 16 wherein a magnetized, movable plunger is used to trigger said reed switch.

18. The fluid filter assembly of claim 1 wherein said housing assembly includes a mechanical air vent that is constructed and arranged to release trapped air.

19. The fluid filter assembly of claim 18 wherein said mechanical air vent includes a spring-biased plunger that is constructed and arranged to be manually movable.

20. In combination:
a. a water dispensing faucet including a base portion visible to a user and a dispensing spout; and
b. a fluid filter assembly for said water dispensing faucet comprising:
a housing assembly that is constructed and arranged to connect to a spout of a water dispensing faucet;
a cover assembly constructed and arranged to be removably attached to said housing assembly, the attached combination of said cover assembly and said housing assembly defining an interior receiving space;
a replaceable filter cartridge installed into said receiving space for filtering a flow of water before delivery to said dispensing faucet;
wherein said housing assembly includes an LED that is constructed and arranged with an operating circuit to provide illumination in a plurality of different colors depending on the fluid filter assembly status; and
c. a fiber optic lightpipe connecting the illumination of said LED to a lens installed as part of the base of said water dispensing faucet.

21. The combination of claim 20 wherein said housing assembly further includes a circuit board and a plurality of reed switches assembled to said circuit board, said plurality of reed switches being responsive to changes in magnetic flux in order to provide a plurality of electronic indications from the following group of electronic indications, including an electronic indication of the filter cartridge status in terms of useful life, an electronic indication of when a non-approved filter cartridge is installed, an electronic indication when there is no filter cartridge installed, an electronic indication when there is a water leak within the fluid filter assembly, and an electronic indication of when one filter cartridge has been replaced by another filter cartridge.

22. The combination of claim 21 wherein one reed switch is used to sense leakage.

23. The combination of claim 21 wherein one reed switch is used to measure the volume of water that has flowed through said fluid filter assembly.

24. The combination of claim 21 wherein one reed switch is used to reset a flow measuring counter to zero when a replacement filter cartridge is installed.

25. The combination of claim 24 wherein a magnetized, movable plunger is used to trigger said reed switch.

26. The combination of claim 25 wherein said housing assembly includes a mechanical air vent that is constructed and arranged to release trapped air.

27. The combination of claim 26 wherein said mechanical air vent includes a spring-biased plunger that is constructed and arranged to be manually movable.

28. The combination of claim 20 wherein said housing assembly includes a mechanical air vent that is constructed and arranged to release trapped air.

29. The combination of claim 28 wherein said mechanical air vent includes a spring-biased plunger that is constructed and arranged to be manually movable.

30. A fluid filter assembly for a water dispensing faucet comprises:
a housing assembly that is constructed and arranged to connect to a spout of a water dispensing faucet, said housing assembly including a magnetized turbine impeller and a cooperating reed switch;
a cover assembly constructed and arranged to be removably attached to said housing assembly, the attached combination of said cover assembly and said housing assembly defining an interior receiving space;
a replaceable filter cartridge installed into said receiving space for filtering a flow of water before delivery to said dispensing faucet, said magnetized turbine impeller and said cooperating reed switch being arranged so as to register the volume of water passing through said filter cartridge; and
wherein said turbine impeller being assembled to an axial shaft arranged into two separable sections, each of said separable sections being movable by the use of a corresponding living hinge.

31. The fluid filter assembly of claim 30 which further includes a second reed switch that is used to sense leakage.

32. The fluid filter assembly of claim 31 which further includes a third reed switch that is used to reset a flow measuring counter to zero when a replacement filter cartridge is installed.

33. The fluid filter assembly of claim 32 wherein a magnetized, movable plunger is used to trigger said third reed switch.

34. The fluid filter assembly of claim 33 wherein said housing assembly further includes a circuit board, said three reed switches being assembled to said circuit board.

35. The fluid filter assembly of claim 34 which further includes a battery holder, said battery holder being constructed and arranged to slide into electrical contact with said circuit board.

36. The fluid filter assembly of claim 35 which further includes a LED that is constructed and arranged to produce a plurality of different illumination colors for indicating fluid filter assembly conditions.

37. The fluid filter assembly of claim 36 which further includes a remotely-located lens that is operably coupled to said LED to give visual indications of fluid filter assembly conditions.

38. The fluid filter assembly of claim 37 wherein the operable coupling between said lens and said LED is by the use of a fiber optic lightpipe.

39. The fluid filter assembly of claim 38 wherein said housing assembly includes a mechanical air vent that is constructed and arranged to release trapped air.

40. The fluid filter assembly of claim 39 wherein said mechanical air vent includes a spring-biased plunger that is constructed and arranged to be manually movable.

41. The fluid filter assembly of claim 30 wherein said housing assembly includes a mechanical air vent that is constructed and arranged to release trapped air.

42. The fluid filter assembly of claim 41 wherein said mechanical air vent includes a spring-biased plunger that is constructed and arranged to be manually movable.

43. A fluid filter assembly for a water dispensing faucet comprises:
a housing assembly that is constructed and arranged to connect to a spout of a water dispensing faucet, said housing assembly including a manually actuatable mechanical air vent;
a cover assembly constructed and arranged to be removably attached to said housing assembly, the attached combination of said cover assembly and said housing assembly defining an interior receiving space;
a replaceable filter cartridge installed into said receiving space for filtering a flow of water before delivery to said dispensing faucet; and
wherein said mechanical air vent includes a vent chamber constructed and arranged to receive trapped air from within said receiving space upon actuation and said housing assembly defining a vent passageway to automatically vent trapped air received from said receiving space to said water dispensing faucet.

44. The fluid filter assembly of claim 43 wherein said housing assembly includes a plurality of reed switches that are responsive to changes in magnetic flux in order to provide a plurality of electronic indications from the following group of electronic indications, including an electronic indication of the filter cartridge status in terms of useful life, an electronic indication of when a non-approved filter cartridge is installed, an electronic indication when there is no filter cartridge installed, an electronic indication when there is a water leak within the fluid filter assembly, and an electronic indication of when one filter cartridge has been replaced by another filter cartridge.

45. The fluid filter assembly of claim 44 wherein said plurality of reed switches includes three reed switches, wherein a first reed switch is used to sense leakage.

46. The fluid filter assembly of claim 45 wherein a second reed switch is used to measure the volume of water that has flowed through said fluid filter assembly.

47. The fluid filter assembly of claim 46 wherein a third reed switch is used to reset a flow measuring counter to zero when a replacement filter cartridge is installed.

48. The fluid filter assembly of claim 47 wherein a magnetized, movable plunger is used to trigger said third reed switch.

49. The fluid filter assembly of claim 38 which further includes a LED that is constructed and arranged to produce a plurality of different illumination colors for indicating fluid filter assembly conditions.

50. The fluid filter assembly of claim 49 which further includes a remotely-located lens that is operably coupled to said LED to give visual indications of fluid filter assembly conditions.

51. The fluid filter assembly of claim 50 wherein the operable coupling between said lens and said LED is by the use of a fiber optic lightpipe.
